(19) United States
(12) Patent Application Publication
(10) Pub. No.: US 2009/0004084 A1
(43) Pub. Date: Jan. 1, 2009

(54) Exchange Cation Selection in ETS-4 to Control Adsorption Strength and Effective Pore Diameter

(75) Inventors: Valerie Amelia Bell, Edison, NJ (US); Dennis Ray Anderson, Plainsboro, NJ (US); Barry Kevin Speronello, Montgomery Township, NJ (US); Mukto Rai, Marlboro, NJ (US); William Bachop Dolan, Yardley, PA (US)

Correspondence Address: BASF CATALYSTS LLC, 100 CAMPUS DRIVE, FLORHAM PARK, NJ, 07932, US

(73) Assignee: BASF CATALYSTS LLC, Florham Park, NJ (US)

(21) Appl. No.: 12/206,819

(22) Filed: Sep. 9, 2008

Related U.S. Application Data
(62) Division of application No. 11/377,840, filed on Mar. 16, 2006.

(51) Int. Cl. B01D 53/047; B01D 53/54

(52) U.S. Cl. 423/239.2

(57) ABSTRACT

The effective pore diameter of ETS-4 can be controlled without thermal treatment by selecting various combinations of cations to exchange into ETS-4. The effect that any cation mixture has on the ETS-4 can be reduced to the weighted average of the effects of each cation present.

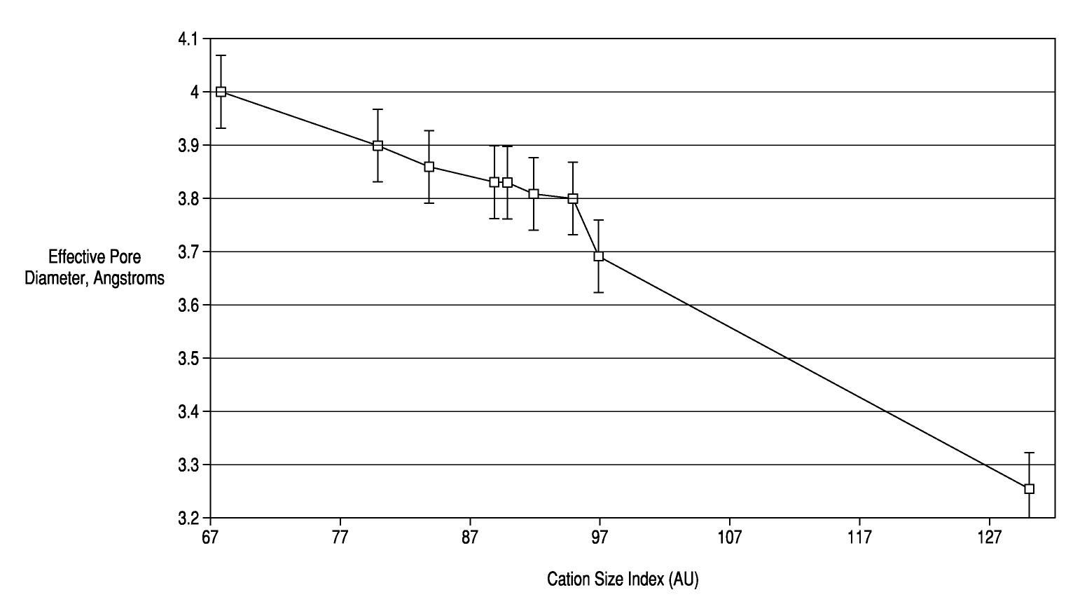

### CROSS REFERENCE TO RELATED APPLICATION

The present application is a divisional of current U.S. Ser. No. 11/377,840, filed Mar. 16, 2006.

### FIELD OF THE INVENTION

Since the discovery by Milton and coworkers (U.S. Pat. Nos. 2,882,243 and 2,882,244) in the late 1950's that aluminosilicate systems could be induced to form uniformly porous, internally charged crystals, analogous to molecular sieve zeolites found in nature, the properties of synthetic aluminosilicate zeolite molecular sieves have formed the basis of numerous commercially important catalytic, adsorptive and ion-exchange applications. This high degree of utility is the result of a unique combination of high surface area and uniform porosity dictated by the “framework” structure of the zeolite crystals coupled with the electro-statically charged sites induced by tetrahedrally coordinated Al⁺³. Thus, a large number of “active” charged sites are readily accessible to molecules of the proper size and geometry for adsorptive or catalytic interactions. Further, since charge compensating cations are electro-statically and not covalently bound to the aluminosilicate framework, they are generally base exchangeable for other cations with different inherent properties. This offers wide latitude for modification of active sites whereby specific adsorbents and catalysts can be tailor-made for a given utility.

In the publication “Zeolite Molecular Sieves”, Chapter 2, 1974, D. W. Breck hypothesized that perhaps 1,000 aluminosilicate zeolite framework structures are theoretically possible, but to date only approximately 150 have been identified. While compositional nuances have been described in publications such as U.S. Pat. Nos. 4,524,055; 4,603,040; and 4,606,899, totally new aluminosilicate framework structures are being discovered at a negligible rate. With slow progress in the discovery of new aluminosilicate based molecular sieves, researchers have taken various approaches to replace aluminum or silicon in zeolite synthesis in the hope of generating either new zeolite-like framework structures or inducing the formation of qualitatively different active sites than are available in analogous aluminosilicate based materials.

It has been believed for a generation that phosphorus could be incorporated, to varying degrees, in a zeolite type aluminosilicate framework. In the more recent past (JACS 104, pp. 1146 (1982); proceedings of the 7^{th} International Zeolite Conference, pp. 103-112, 1986) E. M. Flanigan and coworkers have demonstrated the preparation of pure aluminophosphate based molecular sieves of a wide variety of structures. However, the site inducing Al⁺³ is essentially neutralized by the p⁺⁵, imparting a +1 charge to the framework. Thus, while a new class of “molecular sieves” was created, they are not zeolites in the fundamental sense since they lack “active” charged sites.

Realizing this inherent utility limiting deficiency, the research community, for the past few years, has emphasized the synthesis of mixed aluminosilicate-metal oxide and mixed aluminophosphate-metal oxide framework systems. While this approach to overcoming the slow progress in aluminosilicate zeolite synthesis has generated approximately 200 new compositions, all of them suffer either from the site removing effect of incorporated p⁺⁵ or the site diluting effect of incorporating effectively neutral tetrahedral +4 metal into an aluminosilicate framework. As a result, extensive research in the research community has failed to demonstrate significant utility for any of these materials.

A series of zeolite-like “framework” silicates have been synthesized, some of which have larger uniform pores than are observed for aluminosilicate zeolites. (W. M. Meier, Proceedings of the 7^{th} International Zeolite Conference, pp. 13-22 (1986)). While this particular synthesis approach produces materials which, by definition, totally lack active, charged sites, back implantation after synthesis would not appear out of the question although little work appears in the open literature on this topic.

Another and most straightforward means of potentially generating new structures or qualitatively different sites than those induced by aluminum would be the direct substitution of some charge inducing species for aluminum in a zeolite-like structure. To date the most notably successful example of this approach appears to be boron in the case of ZSM-5 analogs, although iron has also been claimed in similar materials. (EPA 68,796 (1983), Taramasso, et. al.; Proceedings of the 5^{th} International Zeolite Conference; pp. 40-48 (1980)); J. W. Ball, et. al.; Proceedings of the 7^{th} International Zeolite Conference; pp. 137-144 (1986); U.S. Pat. No. 4,280,305 to Kouenhowen, et. al. Unfortunately, the low levels of incorporation of the species substituting for aluminum usually leaves doubt if the species are occluded or framework incorporated.

In 1967, Young in U.S. Pat. No. 3,329,481 reported that the synthesis of charge bearing (exchangeable) titaniumsilicates under conditions similar to aluminosilicate zeolite formation was possible if the titanium was present as a “critical reagent”+III peroxo species. While these materials were called “titanium zeolites” no evidence was presented beyond some questionable X-ray diffraction (XRD) patterns and his claim has generally been dismissed by the zeolite research community. (D. W. Breck, Zeolite Molecular Sieves, p. 322 (1974); R. M. Barrer, Hydrothermal Chemistry of Zeolites, p. 293 (1982); G. Perego, et. al., Proceedings of 7^{th} International Zeolite conference, p. 129 (1986)). For all but one end member of this series of materials (denoted TS materials), the presented XRD patterns indicate phases too dense to be molecular sieves. In the case of the one questionable end member (denoted TS-26), the XRD pattern might possibly be interpreted as a small pored zeolite, although without additional supporting evidence, it appears extremely questionable.

A naturally occurring alkaline titanosilicate identified as “Zorite” was discovered in trace quantities on the Siberian Tundra in 1972 (A. N. Mer'kov, et. al.; Zapiski vses Mineralog. Obshch., pp. 54-62 (1973)). The published XRD pattern was challenged and a proposed structure reported in a later article entitled “The OD Structure of Zorite”, Sandomirskii, et. al., Sov. Phys. Crystallogr. 24(6), November-December 1979, pp. 686-693.

A new family of microporous titanosilicates developed by the present assignee, and generically denoted as ETS, is constructed from fundamentally different building units than classical aluminosilicate zeolites. Instead of interlocked tetrahedral metal oxide units as in classical zeolites, the ETS materials are composed of interlocked octahedral chains and classical tetrahedral rings. In general, the chains consist of six oxygen-coordinated titanium octahedra wherein the chains are connected three dimensionally via tetrahedral silicon oxide units or bridging titanosilicate units. The inherently different crystalline titanium silicate structures of these ETS materials have been shown to produce unusual and unexpected results when compared with the performance of aluminosilicate zeolite molecular sieves. For example, the counter-balancing cations of the crystalline titanium silicates are associated with the charged titania chains and not the uncharged rings which form the bulk of the structure

In U.S. Pat. No. 4,938,939, issued Jul. 3, 1990, Kuznicki disclosed a member of this new family of synthetic, stable crystalline titaniumsilicate molecular sieve zeolites which have a pore size of approximately 3-4 Angstrom units and a titania/silica mole ratio in the range of from 1.0 to 10. The entire content of U.S. Pat. No. 4,938,939 is herein incorporated by reference. These titanium silicates, named ETS-4, have a definite X-ray diffraction pattern unlike other molecular sieve zeolites and can be identified in terms of mole ratios of oxides as follows:

1.0±0.25 M₂/Oₙ:TiO₂:ySiO₂:zH₂O

wherein M is at least one cation having a valence of n, y is from 1.0 to 10.0, and z is from 0 to 100. In a preferred embodiment, M is a mixture of alkali metal cations, particularly sodium and potassium, and y is at least 2.5 and ranges up to about 5.

Members of the ETS-4 molecular sieve zeolites have an ordered crystalline structure and an X-ray powder diffraction pattern having the following significant lines:

TABLE 1
XRD POWDER PATTERN OF ETS-4
(0-40° 2 theta)
SIGNIFICANT d-SPACING (ANGS.) I/Io

| | |
|---|---|
| 11.65 ± 0.25 | S-VS |
| 6.95 ± 0.25 | S-VS |
| 5.28 ± 0.15 | M-S |
| 4.45 ± 0.15 | W-M |
| 2.98 ± 0.05 | VS |

In the above table,
VS = 50-100
S = 30-70
M = 15-50
W = 5-30

A large pore crystalline titanium molecular sieve composition having a pore size of about 8 Angstrom units has also been developed by the present assignee and is disclosed in U.S. Pat. No. 4,853,202, which patent is herein incorporated by reference. This crystalline titanium silicate molecular sieve has been designated ETS-10. In ETS-10, the association of cations with the charged titania chains is widely recognized as resulting in the unusual thermodynamic interactions with a wide variety of sorbates which have been found. This includes relative weak binding of polar species such as water and carbon dioxide and relatively stronger binding of larger species, such as propane and other hydrocarbons. These thermodynamic interactions form the heart of low temperature dessication processes as well as evolving Claus gas purification schemes. The unusual sorbate interactions are derived from the titanosilicate structure, which places the counter-balancing cations away from direct contact with the sorbates in the main ETS-10 channels.

In recent years, scores of reports on the structure, adsorption and, more recently, catalytic properties of wide pore, thermally stable ETS-10 have been made on a worldwide basis. This worldwide interest has been generated by the fact that ETS-10 represents a large pore thermally stable molecular sieve constructed from what had previously been thought to be unusable atomic building blocks.

Although ETS-4 was the first molecular sieve discovered which contained the octahedrally coordinated framework atoms and as such was considered an extremely interesting curiosity of science, ETS-4 has been virtually ignored by the world research community because of its small pores and reported low thermal stability. Recently, however, researchers of the present assignee have discovered a new phenomenon with respect to ETS-4. In appropriate cation forms, the pores of ETS-4 can be made to systematically shrink from slightly larger than 4 Angstrom units to less than 3 Angstrom units during calcinations, while maintaining substantial sample crystallinity. These pores may be “frozen” at any intermediate size by ceasing thermal treatment at the appropriate point and returning to ambient temperature. These controlled pore size materials are referred to as CTS-1 (contracted titanosilicate-1) and are described in commonly assigned, U.S. Pat. No. 6,068,682, issued May 30, 2000. Thus, ETS-4 may be systematically contracted under appropriate conditions to CTS-1 with a highly controllable pore size in the range of 3-4 Angstrom units. With this extreme control, molecules in this range may be separated by size, even if they are nearly identical. The systematic contraction of ETS-4 to CTS-1 to a highly controllable pore size has been named the Molecular Gate® effect. This effect is leading to the development of separation of molecules differing in size by as little as 0.1 Angstrom, such as N₂/O₂ (3.6 and 3.5 Angstroms, respectively), CH₄/N₂ (3.8 and 3.6 Angstroms), or CO/H₂ (3.6 and 2.9 Angstroms). High pressure N₂/CH₄ separation systems are now being developed. This profound change in adsorptive behavior is accompanied by systematic structural changes as evidenced by X-ray diffraction patterns and infrared spectroscopy.

As synthesized, ETS-4 has an approximately 4 Angstrom units effective pore diameter. Reference to pore size or “effective pore diameter” defines the effective diameter of the largest gas molecules significantly adsorbed by the crystal. This may be significantly different from, but systematically related to, the crystallographic framework pore diameter. For ETS-4, the effective pore is defined by eight-membered rings formed from TiO₆²⁻ octahedra and SiO₄ tetrahedra. This pore is analogous to the functional pore defined by the eight-membered tetrahedral metal oxide rings in traditional small-pored zeolite molecular sieves. Unlike the tetrahedrally based molecular sieves, however, the effective pore size of the eight-membered ring in ETS-4 can be systematically and permanently contracted with structural dehydration to CTS-1 materials as above described.

In commonly assigned U.S. Pat. No. 6,517,611, incorporated herein in its entirety by reference, a barium attached ETS-4 was disclosed. Unfortunately, it has been found that no combinations of Ba+2 with Na+1 provides simultaneous optimization of pore diameters and adsorption strength for natural gas or air separation using ETS-4. In various combinations Na/Ba mixtures are either too weakly adsorbing or have pores that are too large to have practical pressure swing applications.

In commonly assigned U.S. Pat. No. 6,395,067, issued May 28, 2002 and U.S. Pat. No. 6,486,086, issued Nov. 26, 2002, there is disclosed a method of separating components from gaseous or liquid mixtures containing same by contacting the mixtures with membranes formed from titanium silicate molecular sieves, including the ETS molecular sieves developed by Engelhard Corporation. The ETS sieves are distinguished from other molecular sieves by possessing octahedrally coordinated titania active sites in the crystalline structure. Membranes formed from ETS-4 molecular sieve are particularly useful inasmuch as the pores of the ETS-4 membranes can be systematically contracted under thermal dehydration to form CTS-1-type materials as disclosed in U.S. Pat. No. 6,068,682. Under thermal dehydration, the pore size of ETS-4 can be systematically controlled from about 4 Å to 2.5 Å and sizes therebetween and frozen at the particular pore size by ending the thermal treatment and returning the molecular sieve to ambient temperature. The ability to actually control the pore size of a particular molecular sieve greatly increases the number of separations achievable by a single molecular sieve unlike previous zeolite membranes in which the adsorption and diffusion properties of the zeolite pores limit what can be separated with a particular type of zeolite membrane.

Unfortunately, during formation of the CTS-1 membranes, cracks can occur, especially during the thermal dehydration step for controlling pore size. Such cracking, greatly disturbs the ability to control the distribution of gases across the membranes.

### SUMMARY OF THE INVENTION

The present invention is directed to a process of systematically controlling the pore size of ETS-4 without the need for thermal treatment and conversion into CTS-1. By selecting various combinations of cations to exchange into ETS-4, the pore size of the sieve can be controlled to affect any particular gas separation application. Surprisingly, unlike most molecular sieves, it has been found that the effect that any cation mixture has on ETS-4 can be reduced to the weighted average of the effects of each cation present.

### BRIEF DESCRIPTION OF THE DRAWING

The FIGURE is a plot of the Cation Size Index developed by the Applicants versus the effective pore diameter of ETS-4.

### DETAILED DESCRIPTION OF THE INVENTION

ETS-4 molecular sieve zeolites can be prepared from a reaction mixture containing a titanium source such as titanium trichloride, a source of silica, a source of alkalinity such as an alkali metal hydroxide, water and, optionally, an alkali metal fluoride having a composition in terms of mole ratios falling within the following ranges.

TABLE 2

| | Broad | Preferred | Most Preferred |
|---|---|---|---|
| SiO₂/Ti | 1-10 | 1-10 | 2-3 |
| H₂O/SiO₂ | 2-100 | 5-50 | 10-25 |
| Mₙ/SiO₂ | 0.1-10 | 0.5-5 | 1-3 |

wherein M indicates the cations of valence n derived from the alkali metal hydroxide and potassium fluoride and/or alkali metal salts used for preparing the titanium silicate according to the invention. The reaction mixture is heated to a temperature of from about 100° C. to 300° C. for a period of time ranging from about 8 hours to 40 days, or more. The hydrothermal reaction is carried out until crystals are formed and the resulting crystalline product is thereafter separated from the reaction mixture, cooled to room temperature, filtered and water washed. The reaction mixture can be stirred although it is not necessary. It has been found that when using gels, stirring is unnecessary but can be employed. When using sources of titanium which are solids, stirring is beneficial. The preferred temperature range is 100° C. to 175° C. for a period of time ranging from 12 hours to 15 days. Crystallization is performed in a continuous or batchwise manner under autogeneous pressure in an autoclave or static bomb reactor. Following the water washing step, the crystalline ETS-4 is dried at temperatures of 100 to 400° F. for periods ranging up to 30 hours.

The method for preparing ETS-4 compositions comprises the preparation of a reaction mixture constituted by sources of silica, sources of titanium, sources of alkalinity such as sodium and/or potassium oxide and water having a reagent molar ratio composition as set forth in Table 2. Optionally, sources of fluoride such as potassium fluoride can be used, particularly to assist in solubilizing a solid titanium source such as Ti₂O₃. However, when titanium silicates are prepared from gels, its value is greatly diminished.

The silica source includes most any reactive source of silicon such as silica, silica hydrosol, silica gel, silicic acid, alkoxides of silicon, alkali metal silicates, preferably sodium or potassium, or mixtures of the foregoing.

The titanium oxide source is a trivalent titanium compound such as titanium trichloride, TiCl₃.

The source of alkalinity is preferably an aqueous solution of an alkali metal hydroxide, such as sodium hydroxide, which provides a source of alkali metal ions for maintaining electrovalent neutrality and controlling the pH of the reaction mixture within the range of 10.45 to 11.0±0.1. Control of pH is critical for the production of ETS-4. The alkali metal hydroxide serves as a source of sodium oxide which can also be supplied by an aqueous solution of sodium silicate.

It is to be noted that at the lower end of the pH range, a mixture of titanium zeolites tends to form while at the upper end of the pH range, quartz appears as an impurity.

The titanium silicate molecular sieve zeolites prepared according to the invention contain no deliberately added alumina, and may contain very minor amounts of Al₂O₃ due to the presence of impurity levels in the reagents employed, e.g., sodium silicate, and in the reaction equipment. The molar ratio of SiO₂/Al₂O₃ will be 0 or higher than 5000 or more.

The as-synthesized ETS-4 can be cation exchanged according to techniques well known in the art and common to most molecular sieves, using cations that are well known in the art, especially groups IA, IIA, IIIB, transition metals and rare earths. A given exchanged ETS-4 product can be dried up to the temperature at which it will either form CTS-1 or collapse, either one being determined by an x-ray diffraction scan. Typical temperatures for drying ETS-4s range from about 65° C. to about 375° C.

When using cation mixtures to fine-tune pore sizes, it is preferred to perform the cation exchange by adding the cation reagent salts simultaneously, not step-wise. Adjustments in the mole percent of each cation reagent added to the exchange solution may be needed to allow for preferential exchange of different cations. The phenomenon of preferential exchange into molecular sieves is also well known in the art. However, for ETS-4 exchanges, it has an unexpected simple correlation with cation electronegativities. The final cation contents should be determined using standard chemical analysis methods such as ICP.

Regardless of the synthesized form of the titanium silicate the spatial arrangement of atoms which form the basic crystal lattices remain essentially unchanged by the replacement of sodium or other alkali metal or by the presence in the initial reaction mixture of metals in addition to sodium, as determined by an X-ray powder diffraction pattern of the resulting titanium silicate. The X-ray diffraction patterns of such products are essentially the same as those set forth in Table I above although the intensities may vary significantly.

The crystalline titanium silicates prepared in accordance with the invention are formed in a wide variety of particular sizes. Generally, the particles can be in the form of powder, a granule, or a molded product such as an extrudate having a particle size sufficient to pass through a 2 mesh (Tyler) screen and be maintained on a 400 mesh (Tyler) screen in cases where the catalyst is molded such as by extrusion. The titanium silicate can be extruded before drying or dried or partially dried and then extruded.

When used as a sorbent, it may be desirable to incorporate the crystalline titanium silicate ETS-4 with another material resistant to the temperatures and other conditions employed in separation processes. Such materials include inorganic materials such as clays, silica and/or metal oxides. The latter may be either naturally occurring or in the form of gelatinous precipitates or gels including mixtures of silica and metal oxides. Normally crystalline materials have been incorporated into naturally occurring clays, e.g., bentonite and kaolin, to improve the crush strength of the sorbent under commercial operating conditions. These materials, i.e., clays, oxides, etc., function as binders for the sorbent. It is desirable to provide a sorbent having good physical properties because in a commercial separation process, the zeolite is often subjected to rough handling which tends to break the sorbent down into powder-like materials which cause many problems in processing. These clay binders have been employed for the purpose of improving the strength of the sorbent.

Naturally occurring clays that can be composited with the crystalline titanium silicate described herein include the smectite, palygorskite and kaolin families, which families include the montmorillonites such as sub-bentonites, attapulgite and sepirotite and the kaolins in which the main constituent is halloysite, kaolinite, dickite, nacrite or anauxite. Such clays can be used in the raw state as originally mined or initially subjected to calcination, acid treatment or chemical modification. The relative proportions of finally divided crystalline metal titanium silicate and inorganic metal oxide can vary widely with the crystalline titanium silicate content ranging from about 1 to 99 percent by weight and more usually in the range of about 80 to about 90 percent by weight of the composite.

In addition to the foregoing materials, the crystalline titanium silicate may be composited with matrix materials such as silica-alumina, silica-magnesia, silica-zirconia, silica-thoria, silica-berylia, silica-titania as well as ternary compositions such as silica-alumina-thoria, silica-alumina-zirconia, silica-alumina-magnesia and silica-magnesia-zirconia. The matrix can be in the form of a cogel.

The present invention can be performed by virtually any known adsorption cycle such as pressure swing (PSA), thermal swing, displacement purge, or nonadsorbable purge (i.e., partial pressure reduction). However, the process of the present invention can be advantageously performed using a pressure swing cycle. Pressure swing cycles are well known in the art.

A particular use of the titanium silicate molecular sieves of this invention is the separation of small polar species such as CO₂, H₂O, N₂ and H₂S from hydrocarbons such as raw natural gas at mildly elevated temperature and full natural gas pressure. In 1993, the Gas Research Institute (GRI) estimated that 10-15% (about 22 trillion cubic feet) of the natural gas reserves in the U.S. are defined as sub-quality due to the contamination with nitrogen, carbon dioxide, and sulfur. Nitrogen and carbon dioxide are inert gases with no BTU value and must be removed to low levels, i.e. less than 4%, before the gas can be sold. The purification of natural gas usually takes place in two stages in which the polar gases such as CO₂, H₂S, SO₂ and water are removed prior to nitrogen removal. Generally, CO₂, H₂S, SO₂ and H₂O removal are currently performed using three separate systems including acid gas scrubbers for removal of H₂S, SO₂ and CO₂, glycol dehydration, and molecular sieve dehydration. At present, nitrogen removal is typically limited to cryogenics. A cryogenic process is expensive to install and operate, limiting its application to a small segment of reserves. For example, a nitrogen content of higher than 15% is needed to render the process economical. Pressure swing adsorption processes utilizing titanium silicate molecular sieves to separate nitrogen from natural gas are being developed and commercialized by the present assignee.

In the present invention, a process model has been determined to quantify cation effects on intrinsic properties of ETS-4 molecular sieve and allow such sieve to be utilized in gas separations without the need for thermal conversion of ETS-4 to CTS-1.

Importantly, it has been found, that unlike most molecular sieves, the effect that any cation mixture has on ETS-4 including pore size control, can be reduced to the weighted average of the effects of each cation present. It has been found that this approach was able to explain all sample behaviors and to predict sample preparations within the precision needed for various separation applications. There are two independent intrinsic properties that can be controlled by the exchange cations that together define the intrinsic properties of the sample.
1) the adsorption strength, important for determining the swing capacity and swing pressure range of a given gas and for manipulating thermodynamic selectivities (“cation charge index”)
2) the cation pore blockage, important for controlling the effective pore diameter to cause size selectivity, without the need for framework shrinkage and its concurrent crystallinity loss (“cation size index”).

More specifically, each cation combination defines the cation charge index and cation size index.

The following empirical relationship exists for the cation charge index:

1) Cation charge index=(equivalents of +2)(75)+(eq. +1) (57)+(eq.+3)(45)

The equation (1) immediately above is a simplified measure of a sample's Henry's Law Constants or adsorption strength (often loosely called heat of adsorption). All cations of the same charge (from Groups IA, IIA or IIIB, and excluding H and Li) have the same adsorption strength. What has been found is that adsorption strength varies as follows: +2>+1>+3. For ETS, the net adsorption strength depends simply on the weighted average of the number of cations of each charge. The numerical values are the initial slopes of the nitrogen adsorption isotherms on ETS-4 samples. The trends are the same for other gases but the magnitudes differ.

The following relationship exists for cation size index:
2) Cation size index=Σ[(percent of exchange sites with cation A) (radius of cation A)] Regardless of the type of cation radii values used from known determinations, the formula accurately predicts the pore size achieved. Particular useful values for cation radius are Pauling Cationic Radii from “The Nature of the Chemical Bond,” Linus Pauling, 3^{rd} ed., Ithica, N.Y., Cornell University Press, 1960. Table 3 below sets forth certain numerical values for Pauling Cationic radii.

TABLE 3
PAULING CATIONIC RADII in ANGSTROMS

| | |
|---|---|
| Li + 1 | 0.60 |
| Na + 1 | 0.95 |
| Cs + 1 | 1.69 |
| Be + 2 | 0.31 |
| Mg + 2 | 0.65 |
| Ca + 2 | 0.99 |
| Sr + 2 | 1.13 |
| Ba + 2 | 1.35 |
| Gd + 3 | 0.96 |
| Na + 1 | 0.95 |
| Cs + 1 | 1.69 |
| In + 3 | 0.81 |
| Y + 3 | 0.93 |
| La + 3 | 1.15 |
| Ce + 3 | 1.01 |
| Pr + 3 | 1.00 |
| Nd + 3 | 0.99 |
| Eu + 3 | 0.97 |
| Gd + 3 | 0.96 |
| Tb + 3 | 0.95 |
| Dy + 3 | 0.94 |
| Ho + 3 | 0.93 |
| Er + 3 | 0.92 |
| Tm + 3 | 0.89 |
| Yb + 3 | 0.89 |
| Sc + 3 | 0.81 |
| B + 3 | 0.20 |
| Tb + 3 | 0.95 |
| Dy + 3 | 0.94 |
| Al + 3 | 0.50 |
| Sc + 3 | 0.81 |
| Ti + 4 | 0.68 |
| V + 5 | 0.59 |
| Cr + 3 | 0.64 |
| Mn + 2 | 0.80 |
| Fe + 3 | 0.60 |
| Fe + 2 | 0.77 |
| Co + 2 | 0.72 |
| Ni + 2 | 0.69 |
| Cu + 1 | 0.96 |
| Zn + 2 | 0.74 |
| Ga + 3 | 0.62 |
| Ag + 1 | 1.26 |
| Sb + 5 | 0.62 |
| Au + 1 | 1.37 |
| Hg + 2 | 1.10 |
| Tl + 3 | 0.95 |
| Pb + 4 | 0.84 |
| Rb + 1 | 1.48 |
| K + 1 | 1.33 |

The above equation (2) is a simplified measure of the total size of cations present that are consuming pore volume. The equation corrects for cation charge such that a cation of charge +2 has ½ the number of cations present and so ½ the net size of a +1 cation of the same radius. Also, equation (2) is effective on a per-gram, not per-zeolite cage, basis. For example, a reference sample of 70% Sr(+2) and 30% Na(+1), has a size index of 35(1.13)+(0.95)=68. This same reference sample has a charge index found from equation (1) of 0.70(75)+(57)=52.5+17.1=69.6 (70).

Using the cation size index as shown in equation (2) and empirical data regarding the correlation between adsorption of gaseous molecules such as methane, nitrogen, oxygen and CO₂ and the pore size of ETS4, an equation has been developed to correlate the effective pore diameter of ETS4 in angstroms and the cation size index “CSI”.

(3) Effective pore diameter (angstroms) equals 4.62−0.009×(CSI).

The equation is graphed more particularly in the FIGURE in which an error of +/−0.075 is set forth for effective pore diameters greater than 3.4 angstroms.

Table 4 sets forth various cation size index values, the pore diameter which was observed, the calculated pore diameter value from equation (3) and the error between the two values.

TABLE 4

| cation | effective | back | |
|---|---|---|---|
| size index | pore diameter | calculated | error |
| 68 | 4 | 4.01 | 0.01 |
| 80 | 3.9 | 3.9 | 0 |
| 84 | 3.86 | 3.86 | 0 |
| 89 | 3.83 | 3.82 | −0.01 |
| 90 | 3.83 | 3.81 | −0.02 |
| 92 | 3.81 | 3.79 | −0.03 |
| 95 | 3.8 | 3.77 | −0.03 |
| 97 | 3.69 | 3.75 | 0.06 |
| 130 | 3.25 | 3.45 | 0.2 |

The pore size calibration from equation (3) and as shown in the FIGURE assumes kinetic diameters of 3.8 angstroms for methane, 3.7 angstroms for argon, 3.64 angstroms for N₂, 3.4 angstroms for O₂, 3.3 angstroms for CO₂ and 2.6 angstroms for H₂O. It also assumes that these molecules behave as spheres and that the pore has a consistent cylindrical shape regardless of its size and as well has smooth walls.

In accordance with the present invention it is now possible to control the pore size of ETS-4 from about 2.5 to 4.0 angstroms by exchanging one or more specific cations or combinations thereof into the ETS-4. By utilizing the cation size index and the FIGURE, the desired pore diameter of ETS-4 can be readily achieved. While exchange of a single cation is effective to control effective pore diameter, it is preferred that a mixture of cations be utilized. The particular cation size index and the calculated pore diameter can be determined by utilizing equations (2) and (3).

To improve adsorption of a particular gaseous constituent, equations (1) and (2) can be used to determine which cation mixtures will match in cation size index and effective pore diameter but differ in charge index. This makes it possible to provide a comparison of the effect of adsorption strength found using the cation charge index. Conversely, if the charge is held constant, the effect of cation sizes on adsorption can be studied.

Many cation combinations are possible to control the effective pore diameter of ETS-4 and control the adsorption strength thereof in accordance with the present invention. For example, it may be preferable to maximize the content of +2 cations to retain strong adsorption. The combination of a 50:50 BaK ETS-4 has an unwanted 20% drop in the total +2 content of a previous commercial reference sample, 70:30 SrNa CTS-1. This drop will cause some loss in total adsorption strength relative to the reference sample when both are in the ETS-4 form. However, a secondary effect works to advantage in the BaK ETS-4 case. For all CTS-1 materials, the adsorption strength decreases systematically with increasing framework shrinkage. This is thought to be because shrinkage causes partial recession of cations out of the pores and decreases the interaction of the adsorbate and the cation. A sample with no framework shrinkage has stronger adsorption than the CTS counterpart. For this reason, it is expected that only a partial sacrifice of adsorption strength results when a 50:50 BaK ETS-4 is used in place of 70:30 SrNa CTS-1. The potential advantages of such applications are numerous. For example, there is no need for framework shrinkage with the difficulty of precise temperature control. There is no need to consider framework shrinkage reversibility, which can occur for CTS-1 pore diameters above about 3.9 angstroms, especially after atmospheric exposure. Heavier ions can be exchanged into ETS-4 to provide a high framework shrinkage temperature meaning that ETS-4 drying can be done at a relatively high temperature without concern for unwanted shrinkage. There will be no crystallinity loss as occurs with CTS-1 formation, so gas capacities are maximized for a given pore diameter within this ETS-4/CTS-1 titanium silicate family. There are indications that the nitrogen adsorption rates are faster, possibly due to more structural uniformity. This would mean enhanced N₂/CH₄ rates.

The cation size index and cation charge index can be used to find optimal impurity adsorption characteristics for a wide variety of separation applications. A particular application is in the removal of impurities from natural gas. For example, in the removal of nitrogen from natural gas it has been found that to provide efficient separation, the cation size index should be about 90 to 100. Preferably, a cation size index of 92-95 can be used. While larger sizes will still adsorb nitrogen, the adsorption will be slower. A cation charge index greater than that achieved with exchange using all monovalent cations is particularly useful. A charge index of 70 or higher is desired since the equilibrium nitrogen capacity and N₂/CH₄ thermodynamic selectivity need to be maintained. A drop of charge index to as low as 66 for samples that have no framework shrinkage can be used.

For nitrogen separation from molecules other than natural gas and larger than nitrogen, the above parameters of cation size index and cation charge index are applicable. Moreover, the choice of cation size index and cation charge index can be optimized for any other type of gas separation. The particular parameters provided will be based on the size of the pore need to provide the desired separation and the strength of adsorption or capacity based on the cation charge index. While it is possible to exchange a single cation into the ETS-4 to achieve the desired size and charge indices, it is preferred to provide a mix of cations which allows more flexibility in achieving the desired size and charge indices to achieve the desired pore size and improve the efficiencies of the particular adsorption which is to take place. It has been found, in particular, with common types of separations such as the removal of impurities from natural gas or for air separation that a mixture of monovalent and divalent or mixture of monovalent with trivalent cations is particularly useful. Again, since it has been found that the adsorption strength is best with a divalent cation, the cation charge index should be maximized by the presence of divalent cations if possible.

We claim:

1. A method of separating nitrogen from a mixture of gases containing nitrogen and gases which are larger than nitrogen comprising; passing said mixture of gases in contact with an ETS-4 molecular sieve, said ETS-4 molecular sieve having been ion exchanged with at least one type of cation, the ion exchanged ETS-4 having a cation size index defined by Σ[(percent of exchange sites with cation A)×(radius of cation A)] of from about 90-100, where cation A represents a type of cation exchanged into said ETS-4.

2. The method of claim 1 wherein said ETS-4 is ion exchanged with a mixture of different cations.

3. The method of claim 1 wherein said ion exchanged ETS-4 has a cation charge index defined by (equivalents of +2 cations)×(75)+(equivalents of +1 cations)×(57)+(equivalents of +3 cations)×(45) of at least 66.

4. The method of claim 2 wherein said cations exchanged into ETS-4 include cations other than having a +1 charge.

5. The method of claim 2 wherein said ETS-4 is ion exchanged with a mixture of cations having +1 and +2 charges.

6. The method of claim 1 wherein said a mixture of gases comprises natural gas.

7. The method of claim 6 wherein said cation size index ranges from about 92-95.

8. The method of claim 7 wherein said ion exchanged ETS-4 has a cation charge index defined by (equivalents of +2 cations)×(75)+(equivalents of +1 cations)×(57)+(equivalents of +3 cations)×(45) of at least 66.

9. The method of claim 1 wherein said nitrogen is separated from said mixture of gases by pressure swing adsorption.

10. The method of claim 9 wherein said mixture of gases comprises natural gas.

11. The method of claim 10 wherein said cation size index ranges from 92-95.
